(19) United States
(12) Patent Application Publication
(10) Pub. No.: US 2018/0137840 A1
(43) Pub. Date: May 17, 2018

(54) TERMINAL APPARATUS AND NON-TRANSITORY COMPUTER READABLE MEDIUM

(71) Applicant: FUJI XEROX CO., LTD., Tokyo (JP)

(72) Inventors: Yoshihiko NEMOTO, Kanagawa (JP); Kengo TOKUCHI, Kanagawa (JP)

(73) Assignee: FUJI XEROX CO., LTD., Tokyo (JP)

(21) Appl. No.: 15/491,585

(22) Filed: Apr. 19, 2017

(30) Foreign Application Priority Data
Nov. 17, 2016 (JP) 2016-224062

(51) Int. Cl. G09G 5/373; G09G 3/3208

(52) U.S. Cl. CPC G09G 5/373; G09G 3/3208; G09G 2330/021; G09G 2340/0492; G09G 2380/02; G09G 2340/04

(57) ABSTRACT

A terminal apparatus includes a display, an acquiring unit, and a processor. The display is capable of changing the size of a viewing region included in a display screen for displaying an image. The viewing region is visible to a user. The acquiring unit acquires viewing-region information about the size of the viewing region. The processor performs a process for an operation performed by the terminal apparatus, on the basis of the viewing-region information acquired by the acquiring unit.

### CROSS-REFERENCE TO RELATED APPLICATIONS

This application is based on and claims priority under 35 USC 119 from Japanese Patent Application No. 2016-224062 filed Nov. 17, 2016.

### BACKGROUND

### Technical Field

The present invention relates to a terminal apparatus and a non-transitory computer readable medium.

### SUMMARY

According to an aspect of the invention, there is provided a terminal apparatus including a display, an acquiring unit, and a processor. The display is capable of changing the size of a viewing region included in a display screen for displaying an image. The viewing region is visible to a user. The acquiring unit acquires viewing-region information about the size of the viewing region. The processor performs a process for an operation performed by the terminal apparatus, on the basis of the viewing-region information acquired by the acquiring unit.

### BRIEF DESCRIPTION OF THE DRAWINGS

Exemplary embodiments of the present invention will be described in detail based on the following figures, wherein:

FIG. 1 is a general view of a terminal apparatus according to an exemplary embodiment;

FIG. 2 is a diagram illustrating an exemplary hardware configuration of the terminal apparatus according to the exemplary embodiment;

FIG. 3 is a diagram for describing functions of a controller according to the exemplary embodiment;

FIG. 4 is a flowchart of a conditional drawing process according to the exemplary embodiment;

FIGS. 5A to 5E are diagrams illustrating exemplary image displays in a combination state;

FIGS. 6A to 6F are diagrams illustrating exemplary image displays in a whole-image maximum-display preference state;

FIGS. 7A and 7B are diagrams for describing an exemplary scroll operation on a display screen;

FIG. 8 is a flowchart of a power/display control process according to the exemplary embodiment;

FIGS. 9A to 9F are diagrams for describing operations in the power/display control process according to the exemplary embodiment; and

FIGS. 10A and 10B are diagrams for describing a terminal apparatus according to a modified example.

### DETAILED DESCRIPTION

Exemplary embodiments of the present invention will be described below with reference to the attached drawings.

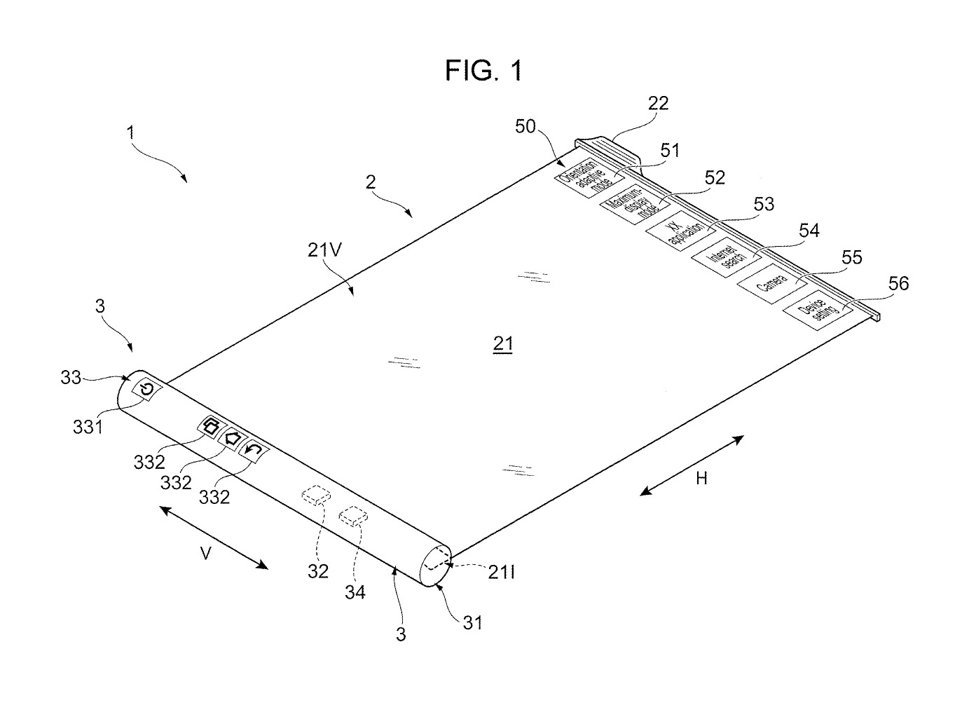

FIG. 1 is a general view of a terminal apparatus 1 according to an exemplary embodiment.

As illustrated in FIG. 1, the terminal apparatus 1 according to the exemplary embodiment includes an image display 2 (exemplary display) that displays an image, and a body portion 3 that accommodates the image display 2 in a way similar to that of a measuring tape. The terminal apparatus 1 is a so-called personal terminal device, such as a smartphone or a tablet personal computer (PC).

The size of the entire terminal apparatus 1 according to the exemplary embodiment is changed in accordance with the state in which the body portion 3 accommodates the image display 2. Therefore, in the exemplary embodiment, when the orientation of the terminal apparatus 1 is described, the body portion 3 is used as a reference. In the exemplary embodiment, the longitudinal direction of the body portion 3 is denoted as the lengthwise direction V of the terminal apparatus 1, and the lateral direction of the body portion 3 is denoted as the transverse direction H of the terminal apparatus 1.

The image display 2 includes a display screen 21 on which an image is displayed, and a tab portion 22 disposed in an end portion of the display screen 21.

The display screen 21 formed of a flexible display material is folded and resized. The display screen 21 according to the exemplary embodiment is pulled out from the body portion 3 or is rolled up into the body portion 3 in the transverse direction H. In the exemplary embodiment, a region (viewing region 21V described below) of the display screen 21 which is pulled out from a housing unit 31 has a planar shape. A region (non-viewing region 211 described below) of the display screen 21 which has been rolled up into the body portion 3 is in a rolled state.

The display screen 21 functions as a touch panel, and detects a contact operation (touch operation) using a user's finger or the like on the display screen 21. As the display screen 21 according to the exemplary embodiment, for example, an organic electroluminescent element (EL) display may be used.

The tab portion 22 forms a portion that is to be held when a user pulls out or rolls up the display screen 21.

The display screen 21 enters a state in which the entire display screen 21 is accommodated in the housing unit 31 or a state in which the entire display screen 21 is pulled out from the housing unit 31. In the exemplary embodiment, the state in which the entire display screen 21 is accommodated is denoted as a “completely closed state” of the display screen 21. The state in which the entire display screen 21 is pulled out is denoted as a “completely open state” of the display screen 21.

The display screen 21 is fixed in a state between the completely closed state and the completely open state. That is, the display screen 21 remains in a state in which the display screen 21 is pulled out from the housing unit 31, at any position between the completely closed state and the completely open state.

A user is not capable of viewing a portion of the display screen 21 which is accommodated in the housing unit 31. In contrast, a user may view a portion which has been pulled out from the housing unit 31. In the exemplary embodiment, an image region of the display screen 21 which is visible to a user is denoted as a viewing region 21V. An image region (an image region other than the viewing region 21V) of the display screen 21 which is invisible to a user is denoted as a non-viewing region 211.

When the display screen 21 is in the completely open state, the viewing region 21V has the largest screen size, i.e., 100%. When the display screen 21 is in the completely closed state, the viewing region 21V has the smallest screen size, i.e., 0%. The viewing region 21V may have a screen size between 0% and 100%.

Thus, the terminal apparatus 1 has a configuration in which the visible viewing region 21V is mechanically changed, enabling the viewing region 21V to be resized.

When the display screen 21 according to the exemplary embodiment is in the completely open state, the length in the transverse direction H is larger than the length in the lengthwise direction V. The display screen 21 in the completely open state (the viewing region 21V having a size of 100%) corresponds to the A4 landscape size.

The body portion 3 includes the housing unit 31 that accommodates the display screen 21, a controller 32 that controls the entire terminal apparatus 1, a body operation portion 33 that receives user operations, and an orientation detection unit 34 that detects the orientation of the terminal apparatus 1.

The housing unit 31 rolls up and accommodates the display screen 21. When the display screen 21 is pulled out, the housing unit 31 lets the display screen 21 out. The housing unit 31 fixes the display screen 21 between the completely open state and the completely closed state of the display screen 21.

When a user pulls out the display screen 21, the housing unit 31 detects the screen size of the viewing region 21V. In the exemplary embodiment, the housing unit 31 estimates the screen size of the viewing region 21V by using various methods, such as use of the rotation amount of a winding shaft for winding the display screen 21, or reading of identification marks provided for the display screen 21.

The controller 32 has overall control of the terminal apparatus 1. The controller 32 performs various types of control, such as power control of the body portion 3 and the display screen 21, display control of an image displayed on the display screen 21, and communication control over a network or the like.

The body operation portion 33 includes a power button 331 and function buttons 332. The power button 331 and the function buttons 332 are constituted by mechanical buttons.

The power button 331 is a button for switching on/off power supply to the entire terminal apparatus 1. The function buttons 332 are buttons for displaying a home screen image on the display screen 21 and returning the display back to display information that has been previously displayed.

The orientation detection unit 34 detects the direction in which the lengthwise direction V of the terminal apparatus 1 is directed. As the orientation detection unit 34, for example, an acceleration sensor or a gyro sensor may be used.

For example, when a user holds the terminal apparatus 1 in such a manner that the lengthwise direction V of the terminal apparatus 1 is parallel to the vertical direction, the orientation detection unit 34 detects the state in which the terminal apparatus 1 is oriented in the vertical direction. In this case, the orientation detection unit 34 also determines which end portion in the lengthwise direction V of the terminal apparatus 1 is positioned on the upper side in the vertical direction.

When a user holds the terminal apparatus 1 in such a manner that the lengthwise direction V of the terminal apparatus 1 is parallel to the horizontal direction, the orientation detection unit 34 detects the state in which the terminal apparatus 1 is oriented in the horizontal direction.

The hardware configuration of the terminal apparatus 1 will be described.

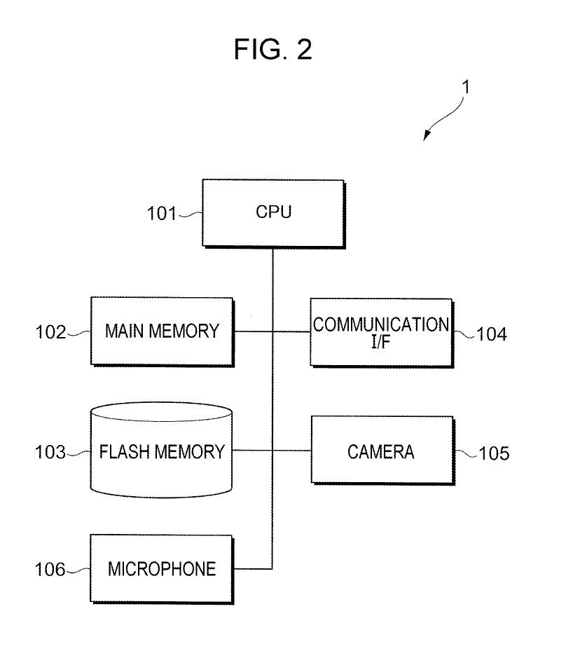

FIG. 2 is a diagram illustrating an exemplary hardware configuration of the terminal apparatus 1 according to the exemplary embodiment.

As illustrated in FIG. 2, the terminal apparatus 1 includes a CPU 101 that is a calculating unit, a main memory 102 that is a memory, and a flash memory 103. The terminal apparatus 1 also includes a communication interface (I/F) 104 for performing communication with the outside, a camera 105, using which a subject or the like is imaged, and a microphone 106 that collects sound.

The CPU 101 executes various programs, such as an operating system (OS) and application software, so as to implement the functions of the terminal apparatus 1. The main memory 102 is a storage area for storing data and the like used for the various programs or their execution. The flash memory 103 is a storage area for storing input data that is input to the various programs, output data that is output from the various programs, and the like.

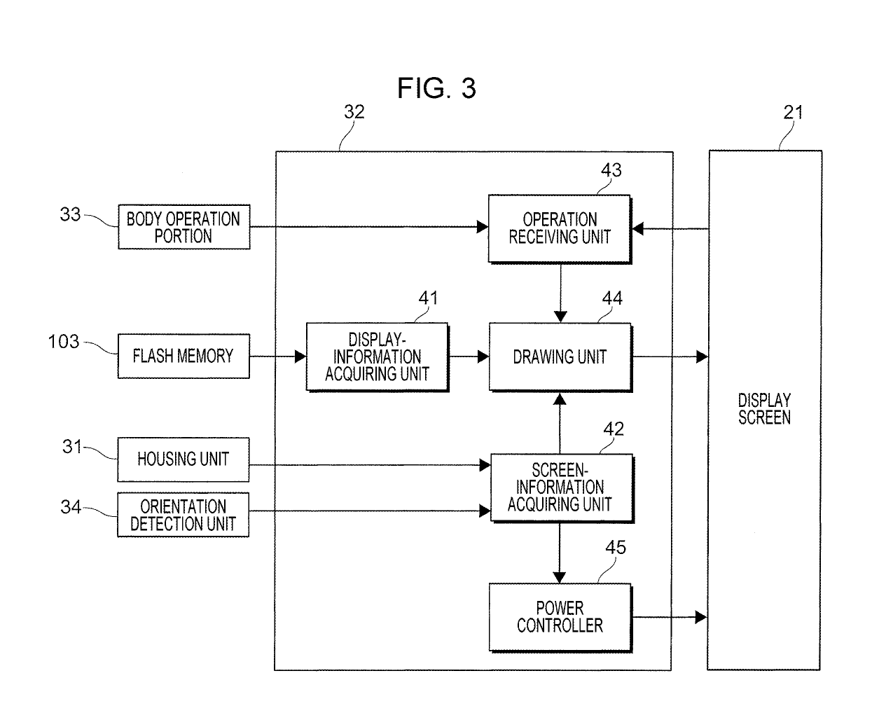

FIG. 3 is a diagram for describing the functions of the controller 32 according to the exemplary embodiment.

As illustrated in FIG. 3, the controller 32 (exemplary processor) includes a display-information acquiring unit 41 that acquires display information displayed on the display screen 21, a screen-information acquiring unit 42 (exemplary acquiring unit) that acquires information about the display screen 21, an operation receiving unit 43 that receives user operations, a drawing unit 44 that draws an image on the display screen 21, and a power controller 45 that controls power supply to the terminal apparatus 1.

The display-information acquiring unit 41 acquires display information that is to be displayed on the display screen 21, from the flash memory 103 or the like. The display information includes drawing data for a display image that is to be displayed on the display screen, and image information that is information about the image size of the display image and the orientation of the display image, i.e., the portrait orientation or the landscape orientation. The display-information acquiring unit 41 transmits the display information to the drawing unit 44.

The screen-information acquiring unit 42 acquires orientation information that is information about the orientation of the terminal apparatus 1 (image display 2), screen size information that is information about the screen size of the viewing region 21V, from the housing unit 31 and the orientation detection unit 34. The screen-information acquiring unit 42 transmits the orientation information and the screen size information to the drawing unit 44.

In the description below, the orientation information and the screen size information may be collectively referred to as screen information (exemplary viewing-region information).

The operation receiving unit 43 receives a pressing operation performed by a user on the body operation portion 33 and a touch operation performed by a user on the display screen 21. The operation receiving unit 43 transmits instructions to the components in accordance with user operations.

In the exemplary embodiment, the operation receiving unit 43 instructs the drawing unit 44 to display operation icons 50 (see FIG. 1) for receiving a user operation, on the display screen 21.

As illustrated in FIG. 1, the operation icons 50 according to the exemplary embodiment include an orientation-adaptive-mode selection icon 51 for receiving setting of the orientation adaptive mode, and a whole-image maximum-display mode selection icon 52 for receiving setting of the whole-image maximum-display mode. The operation icons 50 also include, for example, an application icon 53 that serves as a shortcut of an application, a browser icon 54 that is a button for activating an Internet browser, a camera icon 55 for activating the camera 105, and a setting-screen activation icon 56 for making various settings of the body.

The drawing unit 44 displays an image on the display screen 21 on the basis of the display information acquired from the display-information acquiring unit 41.

The drawing unit 44 scales, rotates, or scrolls the display image for display in accordance with a touch panel operation performed by a user on the display screen 21, or an operation received from a user on the setting screen.

The drawing unit 44 automatically performs a conditional drawing process on the terminal apparatus 1 aside from an operation performed by a user themselves, on the basis of the image information and the screen information.

The conditional drawing process will be described in detail below.

The power controller 45 switches on/off power supply to the entire display screen 21.

The power controller 45 further switches on/off power supply to a part of the display screen 21. As described above, the display screen 21 is accommodated in the housing unit 31. In the exemplary embodiment, the display screen 21 partially switches off power supply to the non-viewing region 211 on the display screen 21.

In the exemplary embodiment, for example, an organic EL display is employed as the display screen 21. In this case, the power controller 45 causes the drawing unit 44 to display black in the non-viewing region 211. Thus, light is not emitted in the non-viewing region 211. Therefore, no power is substantially consumed in the non-viewing region 211. Thus, in the exemplary embodiment, a state in which no images are displayed on a part or all of the display screen 21 has substantially the same meaning as a state in which power supply to a part or all of the display screen 21 is switched off.

The conditional drawing process will be specifically described.

In the conditional drawing process, the following processes are performed: an “orientation adaptive process” of controlling rotation of a display image displayed on the display screen 21 in accordance with the orientation of the terminal apparatus 1; and a “whole-image maximum-display process” of displaying a display image so that the display image is displayed at the maximum size in the viewing region 21V.

In the exemplary embodiment, the mode in which the orientation adaptive process is performed is denoted as an “orientation adaptive mode”, and the mode in which a scaling process is performed is denoted as a “whole-image maximum-display mode”. These modes may be set through user selection.

### Orientation Adaptive Mode

In the orientation adaptive mode (orientation adaptive process), the display image is rotated so that the top and bottom of the display image correspond to those of the terminal apparatus 1 (display screen 21) in accordance with the orientation of the terminal apparatus 1.

When the orientation adaptive mode is not selected, the following default display is performed. For example, the vertical direction of the display image is made parallel to the lengthwise direction V of the terminal apparatus 1, and the top of the display image is placed on the tab portion 22 side. In the state in which the display image is oriented in a certain direction, when the orientation adaptive mode is disabled, the orientation of the display image which is obtained at the time of disabling the orientation adaptive mode is fixed.

In the case where the orientation adaptive mode is not selected, regardless of the direction in which the terminal apparatus 1 is oriented, the state in which the orientation of the display image displayed on the display screen 21 is fixed is maintained.

### Whole-Image Maximum-Display Mode

In the whole-image maximum-display mode (whole-image maximum-display process), the display image is scaled in accordance with the screen size information of the viewing region 21V. In the exemplary embodiment, the whole-image maximum-display mode causes the whole display image to be displayed in the viewing region 21V. In this case, in the whole-image maximum-display mode, when the whole display image is to be displayed, a whole-image maximum-display operation of displaying the whole display image at the maximum possible size in the viewing region 21V while maintaining the aspect ratio of the display image is performed. Specifically, in the whole-image maximum-display mode, the display image is displayed in the viewing region 21V so that, for example, at least one of the lengths of the vertical side and the horizontal side of the display image corresponds to at least one of the lengths of the viewing region 21V in the lengthwise direction V and in the transverse direction H.

When the whole-image maximum-display mode is not selected, the display image is displayed at a display size according to a scaling operation performed by a user, such as display of the display image at a scale factor of 100%.

In the exemplary embodiment, processes for one or both of the orientation adaptive mode and the whole-image maximum-display mode are performed. That is, the following cases are present in the exemplary embodiment: a case in which processes for only the orientation adaptive mode are performed (hereinafter referred to as an orientation-adaptive preference state); a case in which processes for only the whole-image maximum-display mode are performed (hereinafter referred to as a whole-image maximum-display preference state); a case in which processes for both of the orientation adaptive mode and the whole-image maximum-display mode are performed (hereinafter referred to as a combination state); and a case in which no processes for the orientation adaptive mode and the whole-image maximum-display mode are performed.

### Orientation-Adaptive Preference State

In the orientation-adaptive preference state, the orientation of the display image is controlled on the basis of orientation information. In the orientation-adaptive preference state, the display image is rotated in such a manner that priority is placed on the state in which the top and bottom of the terminal apparatus 1 correspond to those of the display image.

### Whole-Image Maximum-Display Preference State

In the whole-image maximum-display preference state, the display image is rotated and scaled so that the whole display image is displayed at the maximum size in the viewing region 21V, on the basis of the image information and the screen size information. In the whole-image maximum-display preference state, the orientation information of the terminal apparatus 1 is not taken into account. That is, in the whole-image maximum-display preference state, the display image is rotated and scaled in accordance with the lengths in the vertical and horizontal directions of the viewing region 21V regardless of the orientation of the image display 2. Therefore, in the whole-image maximum-display preference state, for example, the top and bottom of the display image sometimes do not correspond to the actual top and bottom of the terminal apparatus 1.

### Combination State

In the combination state, the display image is scaled and rotated on the basis of the image information and the screen information (the orientation information and the screen size information). In the combination state, rotation of the display image is first controlled in such a manner that priority is placed on the state in which the top and bottom of the terminal apparatus 1 correspond to those of the display image. Then, in the combination state, the display image is scaled so that the whole display image is displayed at the maximum size in the viewing region 21V.

The conditional drawing process will be described in detail.

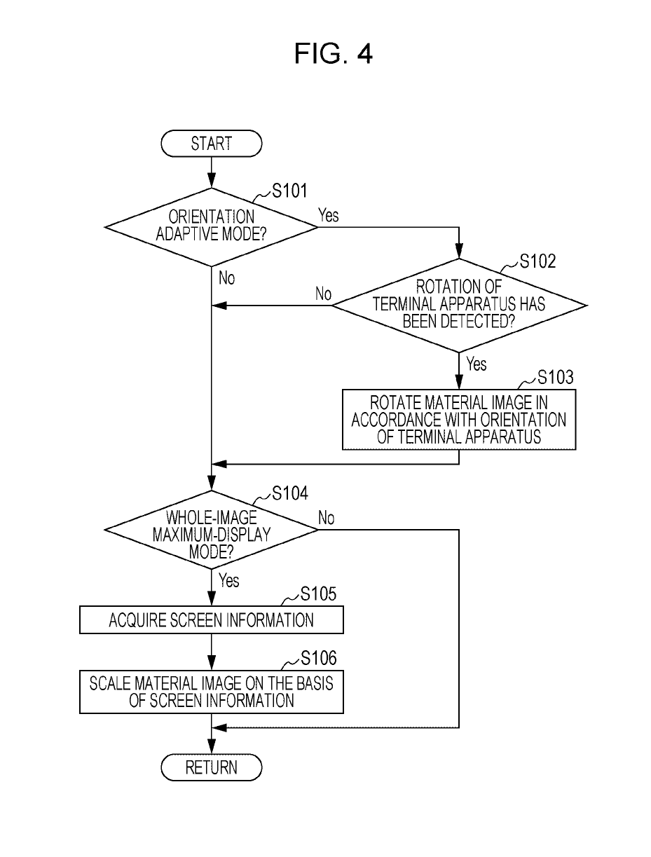

FIG. 4 is a flowchart of the conditional drawing process according to the exemplary embodiment.

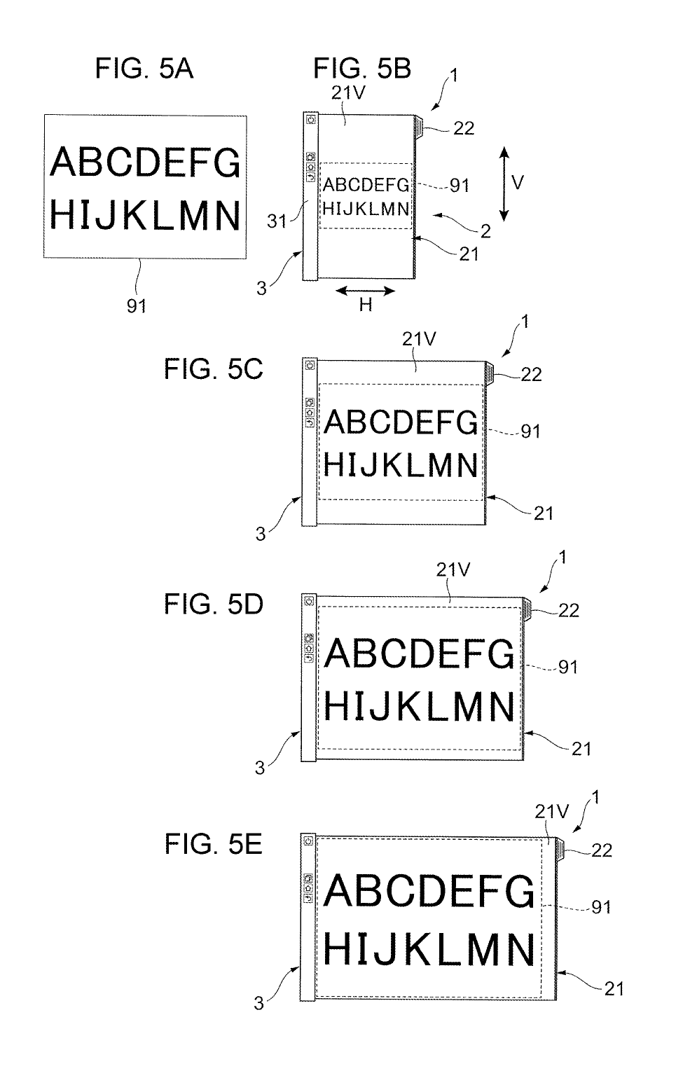

FIGS. 5A to 5E are diagrams illustrating exemplary image displays in the combination state.

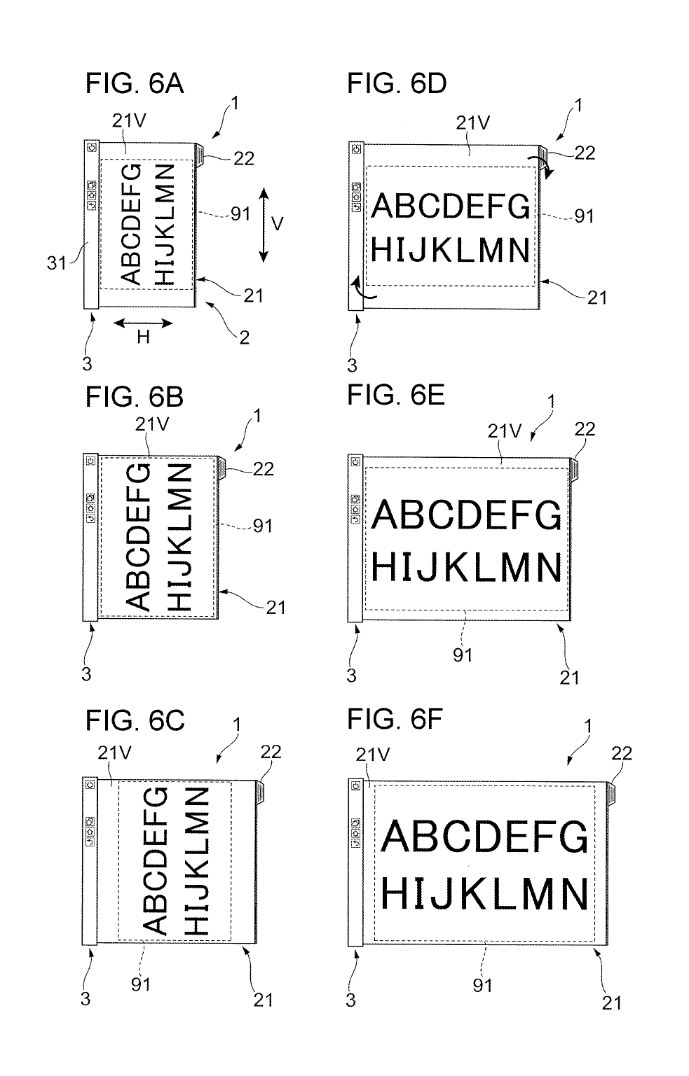

FIGS. 6A to 6F are diagrams illustrating exemplary image displays in the whole-image maximum-display preference state.

In the description below, as illustrated in FIG. 5A described below, a description will be made by taking, as an exemplary display image, a B5-sized material image 91 (exemplary certain image) of landscape orientation. In addition, a case in which the lengthwise direction V of the terminal apparatus 1 is parallel to the up-down direction will be described below as an example.

In the description below, the terminal apparatus 1 is held by a user in such a manner that the lengthwise direction V of the terminal apparatus 1 is parallel to the up-down direction.

As illustrated in FIG. 4, it is determined whether or not the orientation adaptive mode is selected (S(step)101). Selection of the orientation adaptive mode is received from a user, for example, through the orientation-adaptive-mode selection icon 51 (see FIG. 1) displayed on the display screen 21.

If the orientation adaptive mode is selected (Yes in S101), it is determined whether or not a rotational operation on the terminal apparatus 1 has been detected (S102). A rotational operation is detected by the orientation detection unit 34. If a rotational operation on the terminal apparatus 1 has been detected (Yes in S102), a rotational display operation is performed on the material image 91 in accordance with the orientation of the terminal apparatus 1. Specifically, the material image 91 is displayed in such a manner that the top of the material image 91 is placed on the top side of the terminal apparatus 1 (S103). After a rotational operation is performed in S103, the process proceeds to S104.

If no rotational operations on the terminal apparatus 1 have been detected (No in S102), the process proceeds to step 104.

If it is determined that the orientation adaptive mode is not selected in S101 (No in S101), or if no rotational operations have been detected in S102 (No in S102) and a rotational operation has been performed on the material image 91 (S103), it is determined whether or not the whole-image maximum-display mode is selected (S104). Selection of the whole-image maximum-display mode is received from a user, for example, through the whole-image maximum-display mode selection icon 52 (see FIG. 1) displayed on the display screen 21.

Then, the screen-information acquiring unit 42 acquires the screen information of the viewing region 21V (S105). The drawing unit 44 scales the material image 91 for display with respect to the viewing region 21V on the basis of the screen information of the viewing region 21V (S106).

If it is determined that the orientation adaptive mode is selected in S101 (Yes in S101) and it is determined that the whole-image maximum-display mode is selected in S104 (Yes in S104), the terminal apparatus 1 is in the combination state. If it is determined that the orientation adaptive mode is not selected in S101 (No in S101) and it is determined that the whole-image maximum-display mode is selected in S104 (Yes in S104), the terminal apparatus 1 is in the whole-image maximum-display preference state. If it is determined that the orientation adaptive mode is selected in S101 (Yes in S101), and it is determined that the whole-image maximum-display mode is not selected in S104 (No in S104), the terminal apparatus 1 is in the orientation-adaptive preference state.

If it is determined that the orientation adaptive mode is not selected in S101 (No in S101) and it is determined that the whole-image maximum-display mode is not selected in S104 (No in S104), neither of the processes for the modes are performed.

### Exemplary Operations in Combination State

The combination state will be specifically described by referring to FIGS. 5A to 5E.

A case in which the viewing region 21V covers, for example, 40% of the display screen 21 as illustrated in FIG. 5B will be described. In the exemplary embodiment, the housing unit 31 calculates the screen size of the viewing region 21V. The drawing unit 44 scales down the material image 91 to 47% on the basis of the screen size of the viewing region 21V obtained from the housing unit 31, and displays the resulting material image 91 in the viewing region 21V.

A case in which the viewing region 21V covers, for example, 70% of the display screen 21 as illustrated in FIG. 5C will be described. In this case, the drawing unit 44 scales down the material image 91 to 81% on the basis of the screen size obtained from the housing unit 31, and displays the resulting material image 91 in the viewing region 21V.

A case in which the viewing region 21V covers, for example, 86% of the display screen 21 as illustrated in FIG. 5D will be described. In this case, the drawing unit 44 displays the material image 91 at a scale factor of 100% in the viewing region 21V on the basis of the screen size obtained from the housing unit 31.

A case in which the viewing region 21V covers, for example, 100% of the display screen 21 as illustrated in FIG. 5E will be described. In this case, the drawing unit 44 scales up the material image 91 to 115%, and displays the resulting material image 91 in the viewing region 21V.

As described above, when the display screen 21 is pulled out from the housing unit 31, the display size of the material image 91 is first controlled in accordance with the amount by which the display screen 21 has been pulled out, that is, the width of the viewing region 21V in the transverse direction H. After that, when the display screen 21 is further pulled out, the length of the display screen 21 (viewing region 21V) in the lengthwise direction V restricts the display size of the material image 91. Therefore, in the case where the length of the material image 91 in the vertical direction reaches the length of the display screen 21 (viewing region 21V) in the lengthwise direction V, even when the display screen 21 is further pulled out, the display size of the material image 91 remains the same.

The conditional drawing process performed in the combination state is performed similarly to the above-described operations described by referring to FIGS. 5A to 5E, when the transverse direction H of the terminal apparatus 1 is parallel to the up-down direction.

In the combination state, after the whole image is displayed at the maximum size on the display screen 21, when the orientation of the terminal apparatus 1 is changed, the whole material image 91 is similarly displayed at the maximum size on the display screen 21 of the terminal apparatus 1 which has been rotated.

### Exemplary Operations in Whole-Image Maximum-Display Preference State

The whole-image maximum-display preference state according to the exemplary embodiment will be specifically described by referring to FIGS. 6A to 6F.

A case in which the viewing region 21V covers, for example, 40% of the display screen 21 as illustrated in FIG. 6A will be described.

In the exemplary embodiment, the housing unit 31 calculates the screen size of the viewing region 21V. The drawing unit 44 determines the direction of rotation of the material image 91 so that the material image 91 is displayed in the viewing region 21V at the maximum size, on the basis of the screen size obtained from the housing unit 31.

In this example, the length of the display screen 21 in the lengthwise direction V is larger than the length in the transverse direction H. Even if the material image 91 is rotated 90° for display, the whole material image 91 is not capable of being displayed at the maximum size because the width of the viewing region 21V in the transverse direction H is smaller than the width of the material image 91 in the horizontal direction. Therefore, the drawing unit 44 displays the material image 91 so that the horizontal direction of the material image 91 is parallel to the lengthwise direction V of the display screen 21. The drawing unit 44 scales down the material image 91 to 65%, and displays the resulting material image 91 in the viewing region 21V.

A case in which the viewing region 21V covers, for example, 61% of the display screen 21 as illustrated in FIG. 6B will be described. In this example, the length of the display screen 21 in the lengthwise direction V is larger than the length in the transverse direction H. Therefore, the drawing unit 44 displays the material image 91 so that the horizontal direction of the material image 91 is parallel to the lengthwise direction V of the display screen 21. The drawing unit 44 scales down the material image 91 to 82%, and displays the resulting material image 91 in the viewing region 21V.

As illustrated in FIG. 6C, a case in which the viewing region 21V covers, for example, 65% of the display screen 21 will be described. In this example, the length of the display screen 21 in the lengthwise direction V is also larger than the length in the transverse direction H. Therefore, the drawing unit 44 displays the material image 91 so that the horizontal direction of the material image 91 is parallel to the lengthwise direction V of the display screen 21. The drawing unit 44 scales down the material image 91 to 82%, and displays the resulting material image 91 in the viewing region 21V.

As illustrated in FIG. 6D, a case in which the viewing region 21V covers, for example, 70% of the display screen 21 will be described. In this example, the length of the display screen 21 in the transverse direction H is larger than the length in the lengthwise direction V. Therefore, for example, the drawing unit 44 rotates the material image 91 by 90° with respect to the orientation obtained when the viewing region 21V covers 65% of the display screen 21, and displays the material image 91 so that the horizontal direction of the material image 91 is parallel to the transverse direction H of the display screen 21. The drawing unit 44 scales down the material image 91 to 83%, and displays the resulting material image 91 in the viewing region 21V.

As illustrated in FIG. 6E, a case in which the viewing region 21V covers, for example, 86% of the display screen 21 will be described. The drawing unit 44 displays the material image 91 so that the horizontal direction of the material image 91 is parallel to the transverse direction H of the display screen 21. The drawing unit 44 displays the material image 91 at a scale factor of 100% in the viewing region 21V.

As illustrated in FIG. 6F, a case in which the viewing region 21V covers, for example, 100% of the display screen 21 will be described. The drawing unit 44 also displays the material image 91 so that the horizontal direction of the material image 91 is parallel to the transverse direction H of the display screen 21. In this case, the drawing unit 44 scales up the material image 91 to 115%, and displays the resulting material image 91 in the viewing region 21V.

As described above, when the display screen 21 is pulled out from the housing unit 31, the display size and display direction of the material image 91 are first controlled in accordance with the amount by which the display screen 21 is pulled out, that is, the width of the viewing region 21V in the transverse direction H. Then, when the display screen 21 is further pulled out, the width of the display screen 21 (viewing region 21V) in the lengthwise direction H restricts the display size and display direction of the material image 91. At that time, in this example, as illustrated in FIG. 6C, until the length in the transverse direction H is larger than the length in the lengthwise direction V, the drawing unit 44 displays the material image 91 so that the horizontal direction of the material image 91 is parallel to the lengthwise direction V of the display screen 21. In this example, as illustrated in FIG. 6D, when the length in the transverse direction H is larger than the length in the lengthwise direction V, the drawing unit 44 displays the material image 91 so that the horizontal direction of the material image 91 is parallel to the transverse direction H of the display screen 21.

In the exemplary embodiment, the material image 91 is scaled while the aspect ratio of the material image 91 is maintained. Therefore, after the length of the material image 91 that has been scaled up, in the vertical direction reaches the length of the display screen 21 (viewing region 21V) in the lengthwise direction V, even when the display screen 21 is further pulled out, the display size of the material image 91 remains the same.

In the exemplary embodiment, the material image 91 is in landscape orientation in which the length in the horizontal direction is larger than the length in the vertical direction. Even when the material image 91 is in portrait orientation in which the length in the vertical direction is larger than the length in the horizontal direction, control is similarly performed so that the whole image is displayed at the maximum size in the viewing region 21V while the aspect ratio of the material image 91 is maintained.

The examples are described by referring to FIGS. 5A to 6F in the order in which the viewing region 21V of the display screen 21 is gradually enlarged. When the viewing region 21V of the display screen 21 is gradually reduced in size, the operations are performed in the reverse order to the above-described order.

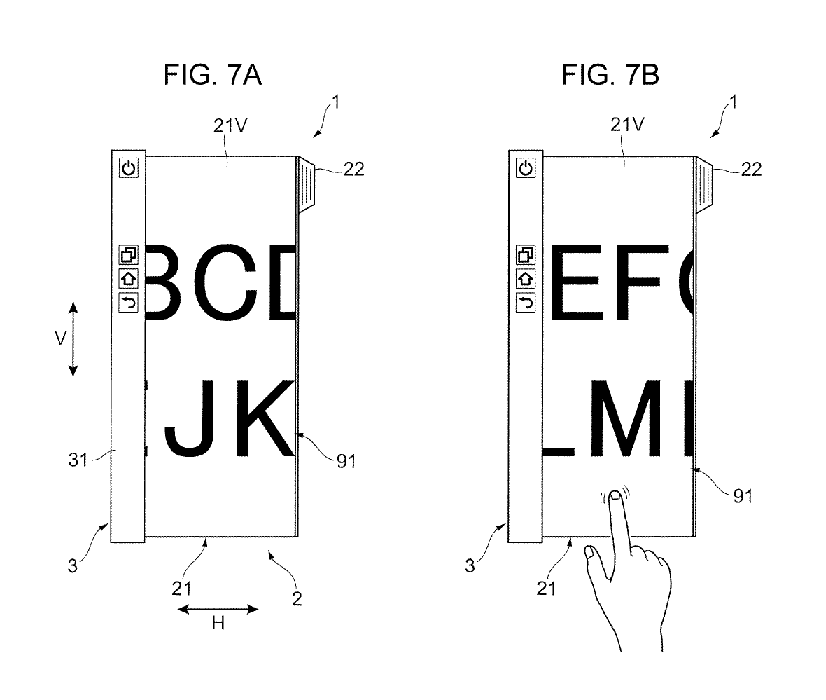

FIGS. 7A and 7B are diagrams for describing an exemplary scroll operation on the display screen 21.

In the exemplary embodiment, a user may select the orientation adaptive mode and/or the whole-image maximum-display mode. Therefore, on the contrary, a user may select the mode (state) in which neither of the orientation adaptive mode nor the whole-image maximum-display mode is selected. In this case, the terminal apparatus 1 does not automatically control display of the material image 91 on the basis of the screen information. The material image 91 is operated through user operations.

As illustrated in FIG. 7A, for example, a case in which the viewing region 21V covers, for example, 40% of the display screen 21 will be described. In this state, when the whole-image maximum-display mode is not selected, the material image 91 is displayed at a scale factor of 100% in the viewing region 21V. In this case, only a part of the material image 91 is displayed in the viewing region 21V. In the terminal apparatus 1 according to the exemplary embodiment, a user performs a scroll operation using their finger or the like on the display screen 21 so that the material image 91 is scrolled, and another part of the material image 91 which has not been displayed before the operation is displayed.

In the terminal apparatus 1 according to the exemplary embodiment, not only in the case where the whole material image 91 is displayed at the maximum size as in the whole-image maximum-display mode, but also in the case where the material image 91 is displayed at a scale factor of 100%, the entire material image 91 may be checked.

### About Power/Display Control

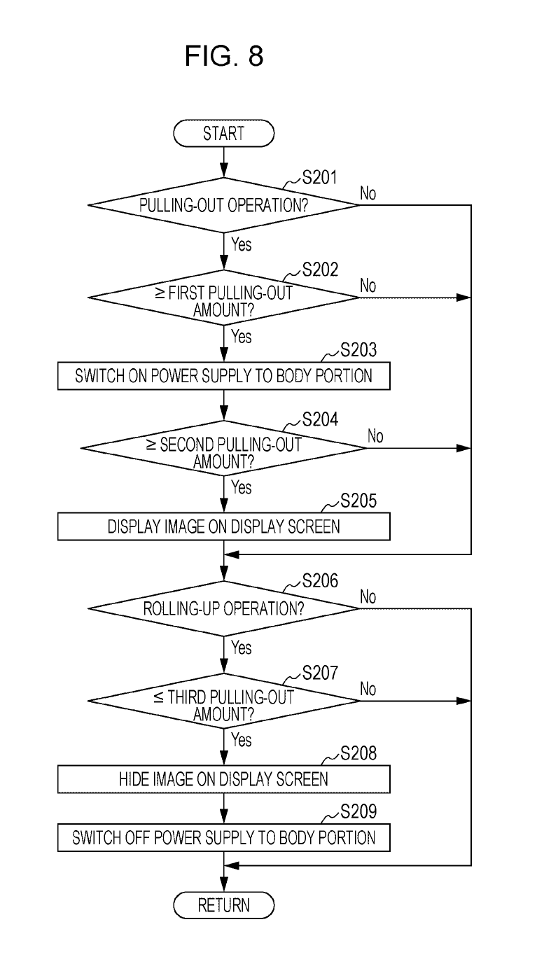

FIG. 8 is a flowchart of a power/display control process according to the exemplary embodiment.

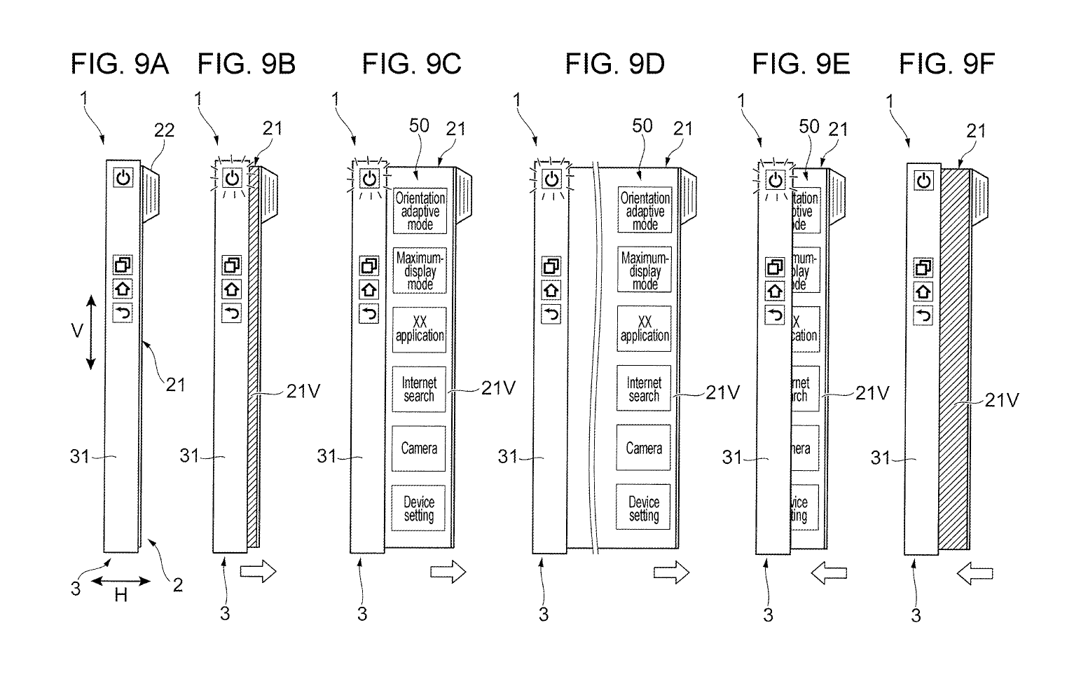

FIGS. 9A to 9F are diagrams for describing operations in the power/display control process according to the exemplary embodiment.

In the description below, as illustrated in FIGS. 9A to 9F, an example in which the display screen 21 of the terminal apparatus 1 which is in the completely closed state is pulled out, and in which the display screen 21 is then returned back to the completely closed state again will be described.

The display screen 21 of the terminal apparatus 1 is in the completely closed state (see FIG. 9A). At that time, the power supply to the body portion 3 is switched off, and no images are displayed on the display screen 21. As illustrated in FIG. 8, it is determined whether or not the display screen 21 has been pulled out (S201). In this step, the housing unit 31 determines whether or not a pulling-out operation has been performed.

If it is determined that a pulling-out operation has been performed in 5201 (Yes in S201), it is determined whether or not the amount by which the display screen 21 is pulled out is equal to or more than a first pulling-out amount (S202). If the amount by which the display screen 21 is pulled out is equal to or more than the first pulling-out amount in S202 (Yes in S202), the power supply to the body portion 3 is switched on (S203).

In the exemplary embodiment, the first pulling-out amount is set to a value slightly larger than a screen size of 0% (completely closed state). That is, in the exemplary embodiment, in a stage in which any of the display screen 21 is pulled out, the power supply to the body portion 3 (the entire terminal apparatus 1) is switched on (see FIG. 9B). In the exemplary embodiment, when any of the display screen 21 that has been in the completely closed state is pulled out, the operation of pulling out the display screen 21 is detected through a mechanical switch, the body portion 3 starts being activated.

In the terminal apparatus 1 according to the exemplary embodiment, in the stage in which power supply to the body portion 3 is switched on, no images are displayed on the display screen 21. That is, in this stage, power is not consumed in the display screen 21.

It is determined whether or not the amount by which the display screen 21 is pulled out is equal to or more than a second pulling-out amount (S204). If it is determined that the amount by which the display screen 21 is pulled out is equal to or more than the second pulling-out amount in S204 (Yes in S204), an image is displayed on the display screen 21 (S205). That is, in the stage in which the amount by which the display screen 21 is pulled out is equal to or more than the second pulling-out amount, power supply to the viewing region 21V is switched on.

The second pulling-out amount is set to a value larger than the first pulling-out amount described above. In the terminal apparatus 1 according to the exemplary embodiment, the second pulling-out amount is set to a value at which all of the operation icons 50 displayed in an end portion of the display screen 21 may be displayed. When the display screen 21 is pulled out so that the amount by which the display screen 21 is pulled out is equal to or more than the second pulling-out amount, the operation icons 50 are displayed on the display screen 21 (see FIG. 9C).

After that, the display screen 21 is further pulled out so that the amount by which the display screen 21 is pulled out is more than the second pulling-out amount, and, for example, the display screen 21 enters the completely open state (see FIG. 9D).

If it is determined that no pulling-out operations have been performed in S201 (No in S201), if it is determined that the amount by which the display screen 21 is pulled out is less than the first pulling-out amount in S202 (No in S202), if it is determined that the amount by which the display screen 21 is pulled out is less than the second pulling-out amount in S204 (No in S204), or after an image is displayed on the display screen 21 in S205, it is determined whether or not an operation of rolling up the display screen 21 has been performed on the display screen 21 (S206).

If it is determined that no operations of rolling up the display screen 21 have been performed on the display screen 21 in S206 (No in S206), the process returns back to S201. In contrast, if it is determined that an operation of rolling up the display screen 21 has been performed on the display screen 21 in S206 (Yes in S206), it is determined whether or not the amount by which the display screen 21 is pulled out is equal to or less than a third pulling-out amount (S207).

If it is determined that the amount by which the display screen 21 is pulled out is not equal to or less than the third pulling-out amount in S207 (No in S207), the process returns back to S201. In contrast, if it is determined that the amount by which the display screen 21 is pulled out is equal to or less than the third pulling-out amount in S207 (Yes in S207), the image is hidden on the display screen 21 (S208). Further, power supply to the body portion 3 (terminal apparatus 1) is switched off (S209).

The third pulling-out amount is set to a value larger than the second pulling-out amount. In the exemplary embodiment, the third pulling-out amount is set to a value corresponding to half the width (in the transverse direction) of the operation icons 50 displayed in the end portion of the display screen 21 (see FIG. 9E). Unlike the state in which the display screen 21 that has been in the completely closed state is pulled out, the display screen 21 starts to be rolled up in a state in which the operation icons 50 are displayed on the display screen 21. Therefore, in the exemplary embodiment, display of the display screen 21 is continued until the third pulling-out amount at which half of each of the operation icons 50 is displayed. In contrast, when half or more of each of the operation icons 50 is hidden, the operation icons 50 are difficult to view and are difficult to operate, for example, using a user's finger or the like. In this state, the image is hidden on the display screen 21 (see FIG. 9F).

As described above, in the terminal apparatus 1 according to the exemplary embodiment, the size of the viewing region 21V which triggers an operation of switching on power supply to the terminal apparatus 1 itself is different from the size of the viewing region 21V which triggers an operation of switching off the power supply. In addition, in the terminal apparatus 1 according to the exemplary embodiment, the size of the viewing region 21V which triggers an operation of displaying an image on the display screen 21 is different from the size of the viewing region 21V which triggers an operation of hiding an image on the display screen 21.

In the exemplary embodiment, the second pulling-out amount and the third pulling-out amount are set on the basis of the operation icons 50, but are not limited to the examples using the operation icons 50. The second pulling-out amount and the third pulling-out amount may be set on the basis of another condition.

In the terminal apparatus 1, a display region that is fixed so as not to be accommodated in the housing unit 31 may be provided, and may be operated as an auxiliary display or a user interface unit. For example, as illustrated in FIG. 9C, a configuration may be employed in which the operation icons 50 displayed in the end portion of the display screen 21 are not accommodated, and in which a part of the display screen 21 is always exposed.

When an image is not displayed on the display screen 21 in a state in which the display screen 21 is stored in the housing unit 31, an operation or function through input/output of voice may be performed. For example, an instruction (such as mode setting) from a user on display on the display screen 21 may be received by using user's voice.

A terminal apparatus 11 according to a modified example will be described.

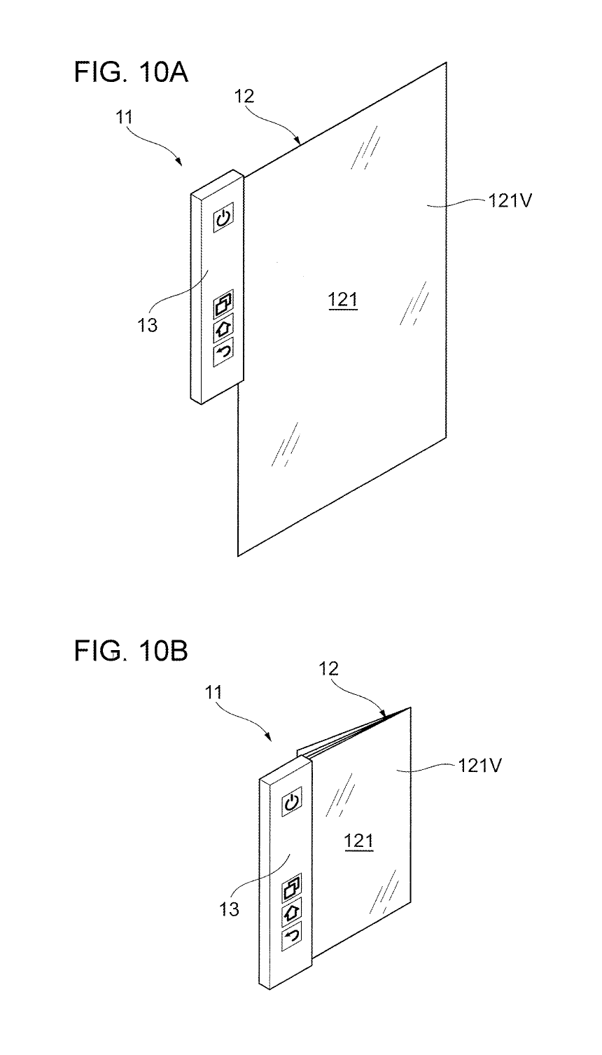

FIGS. 10A and 10B are diagrams for describing the terminal apparatus 11 according to the modified example. FIG. 10A is a perspective view of the entire terminal apparatus 11 according to the modified example. FIG. 10B is a diagram illustrating the terminal apparatus 11 after a resizing operation.

In the terminal apparatus 1 according to the exemplary embodiment described above, the display screen 21 is pulled out from the housing unit 31 and is rolled up into the housing unit 31 so that a display screen region (viewing region 21V) that is visible to a user is mechanically changed. In such a configuration in which the viewing region 21V is mechanically changed, display of the material image 91 is controlled in the conditional drawing process. However, the conditional drawing process is not limited to the way which is employed in the terminal apparatus 1 and in which the display screen 21 is pulled out from the housing unit 31 and is rolled up into the housing unit 31.

As will be described below, the terminal apparatus 11 that enables the display screen to be folded at any position for resizing may be used.

As illustrated in FIG. 10A, the terminal apparatus 11 includes an image display 12 having a display screen 121, and a body portion 13. As illustrated in FIG. 10B, the image display 12 may be folded at any position, and an image may be displayed even in the folding state. That is, in the terminal apparatus 11 according to the modified example, a viewing region 121V on the display screen 121 may be resized.

The basic configuration of the body portion 13 is similar to that of the body portion 3 of the terminal apparatus 1 described above.

In the terminal apparatus 11, screen information of the display screen 121 visible to a user may be also obtained. Specifically, in the terminal apparatus 11, an action unit (not illustrated) that is provided with a touch panel function and that may detect a touch of the display screen 21 is provided on the surface of the display screen 121. Thus, for example, when the display screen 121 is folded, the action unit (not illustrated) touches the display screen 121 so that screen size information of the viewing region 121V is obtained.

In the terminal apparatus 11 according to the modified example having the above-described configuration, the whole-image maximum-display process and/or the orientation adaptive process are also performed on the basis of the screen information.

In the description about the exemplary embodiment, in the terminal apparatus 1 and the terminal apparatus 11 according to the modified example, the apparatus automatically obtains screen information. This is not limiting. For example, the terminal apparatus 1 and the terminal apparatus 11 may obtain screen information through an input operation performed by a user.

The above-described conditional drawing process may be regarded as a program causing a computer to implement a function of obtaining viewing-region information about the size of the viewing region 21V, and a function of performing processes for the operations of the terminal apparatus on the basis of the obtained viewing-region information. The computer functions as a terminal apparatus (for example, the terminal apparatus 1 or the terminal apparatus 11) provided with a display in which a viewing region that is included in a display screen for displaying an image and that is visible to a user may be resized.

The program for causing the computer to implement the functions of the components according to the exemplary embodiment may be provided not only, for example, through a communication unit but also through various recording media such as a digital versatile disk (DVD) storing the program.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A terminal apparatus comprising:
a display that is capable of changing a size of a viewing region included in a display screen for displaying an image, the viewing region being visible to a user;
an acquiring unit that acquires viewing-region information about the size of the viewing region; and
a processor that performs a process for an operation performed by the terminal apparatus, on a basis of the viewing-region information acquired by the acquiring unit.

2. The terminal apparatus according to claim 1,
wherein the processor displays an image on the display screen on a basis of the viewing-region information acquired by the acquiring unit.

3. The terminal apparatus according to claim 2,
wherein, when displaying a certain image having a predetermined size, the processor displays the certain image in the viewing region in such a manner that the whole certain image is displayed at a maximum size in the viewing region.

4. The terminal apparatus according to claim 3,
wherein, regardless of an orientation of the display, the processor rotates the certain image in accordance with a length and a width of the viewing region so as to display the certain image in the viewing region.

5. The terminal apparatus according to claim 1,
wherein the processor controls power supply to the terminal apparatus on a basis of the viewing-region information acquired by the acquiring unit.

6. The terminal apparatus according to claim 5,
wherein the processor switches on or off the power supply to the terminal apparatus in accordance with the viewing-region information, and
wherein the size of the viewing region which triggers the operation of switching on power is different from the size of the viewing region which triggers the operation of switching off power.

7. The terminal apparatus according to claim 6,
wherein the processor displays or hides an image on the display screen in accordance with the viewing-region information, and
wherein the size of the viewing region which triggers the operation of displaying an image on the display screen is different from the size of the viewing region which triggers the operation of hiding an image on the display screen.

8. A non-transitory computer readable medium storing a program causing a computer to execute a process, the computer functioning as a terminal apparatus provided with a display that is capable of changing a size of a viewing region included in a display screen for displaying an image, the viewing region being visible to a user, the process comprising:
acquiring viewing-region information about the size of the viewing region; and
performing a process for an operation performed by the terminal apparatus, on a basis of the acquired viewing-region information.
